(19) United States
(12) Patent Application Publication
(10) Pub. No.: US 2015/0235009 A1
(43) Pub. Date: Aug. 20, 2015

(54) Method and System for Generating a Rate-of-Change Graphical Health Record

(71) Applicant: Hillel Kashtan, Poquoson, VA (US)

(72) Inventor: Hillel Kashtan, Poquoson, VA (US)

(21) Appl. No.: 14/544,555

(22) Filed: Jan. 21, 2015

Related U.S. Application Data
(60) Provisional application No. 61/966,200, filed on Feb. 18, 2014.

(51) Int. Cl. G06F 19/00

(52) U.S. Cl. CPC G06F 19/363

(57) ABSTRACT

An electronic health record is generated using a processor and electronic data storage. Feature descriptions are stored in the data storage. Each feature description defines patient-answerable data queries associated with a health issue. The data storage also stores sets of periodic responses to the data queries with each set being associated with a time period. The processor processes the sets of periodic responses to generate a graphical presentation thereof that orders the sets on a common time scale based on the time period for display on a device.

Pursuant to 35 U.S.C. §119, the benefit of priority from provisional application 61/966,200, with a filing date of Feb. 18, 2014, is claimed for this non-provisional application.

### FIELD OF THE INVENTION

The invention relates generally to patient health records, and more particularly to a method and system that provides for the remote collection of patient information over a period of time and the generation of a graphical health record that illustrates information interrelationships in a rate-of-change format.

### BACKGROUND OF THE INVENTION

Medical records kept by providers (e.g., physicians, hospitals, etc.) are maintained for each patient and updated when the patient is seen. However, during the course of a patient's ongoing treatment, the patient is away from the physician's office or hospital. Indeed, the vast majority of a patient's care and treatment is maintained and monitored by the patient himself such that the vast majority of official medical records are updated “after the fact” based on patient recall. In cases of disease and chronic illness, this type of record keeping makes it difficult for a physician to evaluate time-lapse trends in terms of the interrelationships between conditions and symptom manifestations, symptom severity, symptom progression, medications, diet, activity or exercise, etc. Since patients generally only explain their symptoms when they are questioned by a healthcare professional (e.g., at a physician appointment), a physician generally only makes changes to patient care predicated on a patient's current monitored conditions and the patient's current-state responses. Unfortunately, this ignores longer trends in a patient's care and treatment history even though longer trend histories provide a more accurate description of a patient's well-being as well as the effectiveness of prescribed care.

### SUMMARY OF THE INVENTION

Accordingly, it is an object of the present invention to provide a system and method for presenting time-lapse trends for a patient.

Another object of the present invention is to provide a patient and the patient's care providers with a tool to monitor time-lapse interrelationships between parameters impacting a patient's well-being.

Still another object of the present invention is to provide a tool that allows a patient to remotely provide care-related information that can then be remotely monitored by a healthcare provider(s) and/or healthcare-based organization(s).

Yet another object of the present invention is to provide a method and system for generating a health record that graphically presents time-lapse interrelationships between parameters impacting a patient's well-being.

Other objects and advantages of the present invention will become more obvious hereinafter in the specification and drawings.

In accordance with the present invention, a method and system are provided for generating a health record using a processor and electronic data storage. Feature descriptions are stored in the data storage. Each feature description defines patient-answerable data queries associated with a health issue. The data storage also stores sets of periodic responses to the data queries. Each set is associated with a time period. The processor processes the sets of periodic responses to generate a graphical presentation thereof. The graphical presentation orders the sets on a common time scale based on the time period and is displayed on a device.

### BRIEF DESCRIPTION OF THE DRAWINGS

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is a schematic view of an internet-based system for the generation of a graphical health record in accordance with an embodiment of the present invention;

FIG. 2 is a table listing measured parameters, uniformly-scaled symptom definitions, and Boolean activities forming a pre-set feature description in accordance with an embodiment of the present invention;

FIG. 3 is a graphical health record presentation for a patient/user illustrating interrelationships for a pre-set feature description in accordance with an embodiment of the present invention;

FIG. 4 is a table listing measured parameters, nonuniformly-scaled symptom definitions, and Boolean activities forming a modified feature description in accordance with another embodiment of the present invention;

FIG. 5 is a graphical health record presentation for a patient/user illustrating interrelationships for the modified feature description listed in FIG. 4;

FIG. 6 is a graphical health record presentation for a patient/user illustrating interrelationships for a pre-set feature description and a time-aligned disease score in accordance with another embodiment of the present invention; and

FIG. 7 is a graphical health record presentation for a patient/user illustrating interrelationships for a pre-set feature description and a time-aligned and weighted disease score in accordance with another embodiment of the present invention.

### DETAILED DESCRIPTION OF THE INVENTION

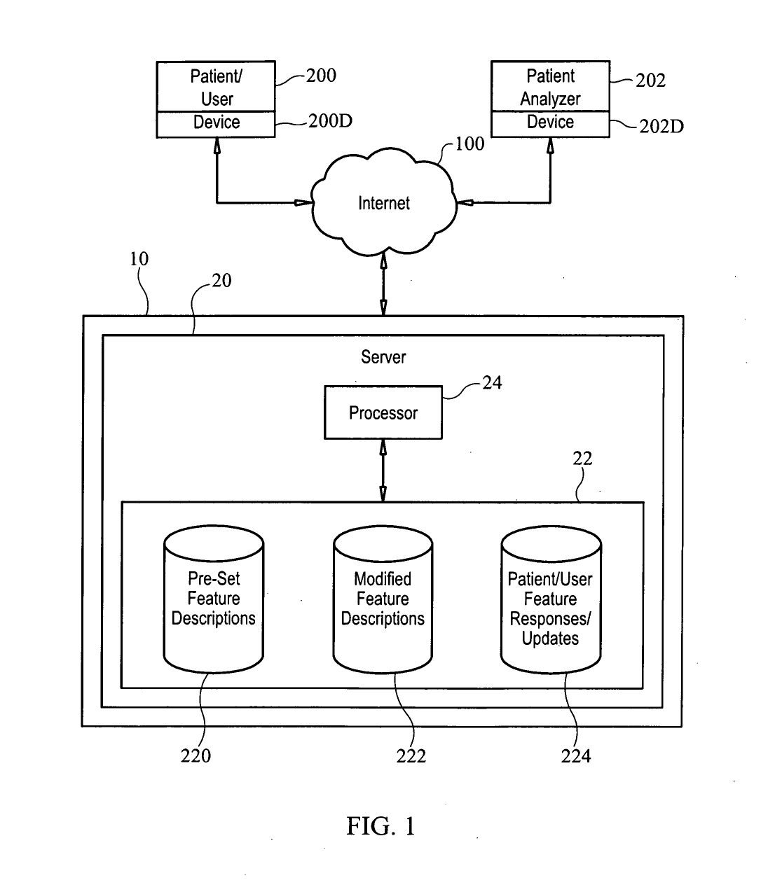

Referring now to the drawings and more particularly to FIG. 1, an internet-based system for the generation of a graphical health record presentation of patient-related information in accordance with an embodiment of the present invention is shown and is referenced generally by numeral 10. As will be explained further below, system 10 is a username/password-based and protected system that allows registered and approved users to access the system via internet 100. A “user” as referred to herein can be a patient as well as non-patients such as physicians, provider facilities (e.g., hospital, clinic, etc.), research facilities, labs, foundations, medical schools, insurance companies, pharmaceutical companies, etc. The type and frequency of access to system 10 could be predicated on a user's type. It is to be understood that the permission/restriction of access to system 10 can be achieved in a variety of ways known in the art without departing from the scope of the present invention.

System 10 relies on the remote entry (by a patient/user) of information related to the patient's condition, disease, illness, etc. Accordingly, a patient/user is illustrated in FIG. 1 and is referenced by numeral 200. Although just one patient/user 200 is shown in FIG. 1, it is to be understood that system 10 will support use thereof simultaneously by multiple patient/users.

Non-patient user(s) of system 10 that are able to access the information related to patient/user 200 could include one or more of the other user types listed above and will be referred to herein as “patient analyzers”. For purpose of describing the present invention, it is sufficient that there is one such patient analyzer of the information related to patient/user 200. Accordingly, only a single patient analyzer 202 is shown in FIG. 1. However, it is to be understood that system 10 will support the use thereof simultaneously by multiple patient analyzers. In accordance with the present invention, patient analyzer 202 will be presented with time-aligned health record for patient/user 200. The types of use and/or processing of the health record by patient analyzer 202 are not limitations of, or part of, the present invention.

It will be assumed that each of patient/user 200 and patient analyzer 202 will have access to a device 200D and 202D, respectively, that can communicate bi-directionally over internet 100 and display information thereon. Such devices include, but are not limited to, desktop and laptop computers, tablets, smartphones, etc. The choice of device used by patient/user 200 and patient analyzer 202 is not a limitation of the present invention. Operation of such devices is well-understood in the art and will not be described further herein. Each of devices 200D and 202D will be capable of accessing system 10 by, for example, a “universal resource locator” (URL) entered on the device, an application or “app” downloaded on the device, etc., as would be understood in the art.

System 10 can be implemented as an internet-based system that includes a server 20. Server 20 can be any conventional server hardware that generally includes electronic data storage 22 and server processor 24 as would be understood by one of ordinary skill in the art. Server 20 could also be realized by third-party-operated, cloud-based systems providing the functionality that will be described further below. Accordingly, it is to be understood that the choice of system that provides server operations is not a limitation of the present invention.

Processor 24 provides the processing platform for receiving all incoming inputs from registered/authorized users, generating graphical presentations that essentially define a health history/record, and controlling the distribution of the graphical presentations as will be explained further below. Data storage 22 and processor 24 could be incorporated in a single system or could be separate hardware/software system(s) without departing from the scope of the present invention.

Data storage 22 defines a number of databases for access by registered/authorized users of system 10. The databases can be separate hardware devices or a single hardware device with separate storage “areas” defined by software structures without departing from the scope of the present invention. Although not illustrated, database 20 will typically also include a database of authorized users, usernames, passwords, etc., that will be verified by processor 24 prior to permitting any access to the system's other databases. Since user verification and security methods are well-known in the art, they will not be described herein. Instead, the following description will assume proper user verification, and will focus on the databases and processing that contribute to the novel functionality provided by the present invention.

A database 220 stores a plurality of pre-set feature descriptions with each such feature description defining data queries associated with a particular health issue (e.g., illness, disease, etc.) where such data queries are readily answerable by a patient experiencing the health issue. Each pre-set feature description can define, for example, a number of scaled symptom definitions associated with a particular health issue, a number of measurable parameters of interest/concern for the particular health issue, and a number of Boolean-type patient activities (i.e., specific activity is either performed or not performed) of interest/concern for the particular health issue. Each pre-set feature description is designed to elicit related information from a patient/user for a particular condition on a time increment or period basis. That is, the data queries for a feature description are indexed to a time scale that is relevant to the corresponding health issue. As will be explained further below, a pre-set feature description could also be modified for a particular patient/user.

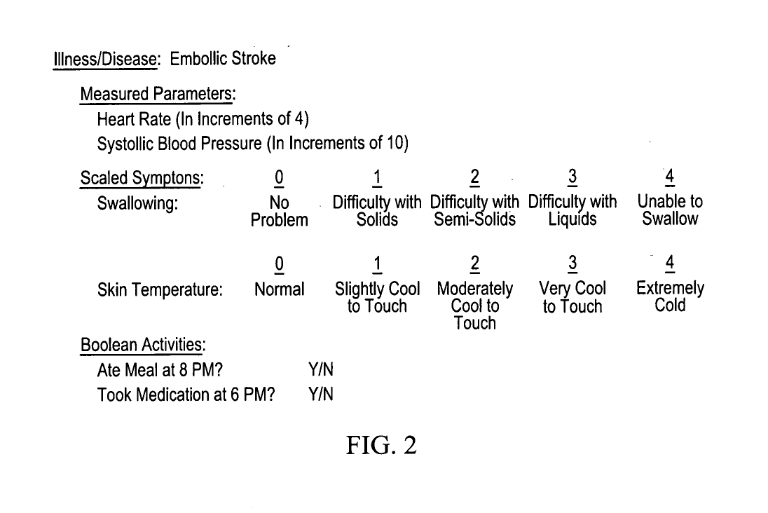

In order to aid in a description of the present invention, one exemplary pre-set feature description is presented in FIG. 2 for an embolic stroke. However, it is to be understood that other pre-set feature descriptions could be used for an embolic stroke without departing from the scope of the present invention. Further, it is to be understood that database 220 will generally store pre-set feature descriptions for a large variety of illnesses/diseases.

For simplicity, FIG. 2 lists two scaled symptom definitions, two measured parameters, and two Boolean-type activities. A pre-set feature description can have more or less than two symptom definitions, two measured parameters, and/or two Boolean activities without departing from the scope of the present invention. For the illustrated embodiment, the two scaled symptom definitions are related to swallowing and skin temperature. In the illustrated example, each scaled symptom definition uses the same or uniform “scaling” (e.g., a scaled score of 0, 1, 2, 3 or 4) with each score being associated with a pre-set symptom definition for an embolic stroke. As will be explained further below, a patient/user selects a scaled score that best represents his symptom during each designated time period or point in time, (e.g., every hour, every day at 8 AM and 8 PM, once a day, etc.). The two measured parameters in the illustrated example are heart rate and systolic blood pressure. It is assumed that the patient/user is equipped to measure the defined parameters at each designated time period or point in time. Rounding increments can be used to limit patient/user entry to an acceptable measurement increment (e.g., heart rate in increments of 4 beats per minute, blood pressure in increments of 10 mmHg). The two Boolean activities in the illustrated example elicit a “YES” or “NO” response from the patient/user regarding, for example, important activities related to their particular illness/disease, e.g., eating and medication scheduling in the illustrated example.

As mentioned above, system 10 provides for modification of each pre-set feature description stored in database 220. Such modifications could be made by a patient/analyzer 202 for a particular patient/user 200 based on particular needs of the patient/user or particular concerns of patient analyzer 202. Another possibility is that modifications are made for a group of patients/users that are taking part in a medical study and/or medication study. Accordingly, system 10 can include another database 222 with modified feature descriptions having “username” associations where a “username” could be a particular patient/user, the name of a medical and/or medication study group, etc. Generally, modifications that result in an entry into database 222 are made before patient/user 200 uses system 10. Some exemplary modifications will be explained further below.

System 10 provides another database 224 that stores responses/updates made by patient/user 200. These responses/updates will be used by processor 24 to generate graphical presentations thereof that are then made available to a registered/authorized patient analyzer 202 associated with patient/user 200. Briefly, processor 24 transforms the information stored in database 224 into a graphical presentation that provides patient analyzer 202 with information interrelationships based on a rate of change as will be described further below. The graphical presentations could be made available in a real-time mode and/or in an archived mode.

In operation, system 10 provides (via programming in processor 24) the ability to register and authenticate authorized users (i.e., patient/users 200 and patient analyzers 202) in ways well-understood in the art. Generally, patient analyzer 202 provides system 10 with information on patient/user 200 that allows patient/user 200 to be verified prior to initially accessing system 10. Then, when a verified patient/user 200 initially accesses system 10, processor 24 will check database 222 to see if there is a modified pre-set feature description associated with patient/user 200 and provide it to patient/user 200. If no modified feature description exists, processor 24 will select the appropriate “generic” pre-set feature description from database 220 that is appropriate for patient/user 200. Then, either the generic or modified pre-set feature description will be made available to patient/user 200 on their device 200D so that the prescribed information can be periodically submitted by patient/user 200. For example, a feature description could be presented to patient/user 200 on device 200D in a spreadsheet format such that patient/user 200 can input and submit their responses to system 10 using device 200D. Each such submission is stored by system 10 in database 224 at which point patient analyzer 202 can access the information via their device 202D.

The stored information in database 224 is transformed to a graphical/electronic health record for patient analyzer 202. The health record generated by the present invention presents interrelationships between the presented information in a rate-of-change format. In general, the stored information in database 224 for a patient/user is processed/presented by processor 24 in related data query, groups and in an ordered/chronological time-aligned fashion on a common time scale based on the relevant time period specified by the data queries. In this way, a patient/user's health trends can be accurately monitored on a daily, weekly, etc., basis without ever going to a treatment facility. In the illustrated example, the scaled symptom scores provided by patient user 200 describing relevant symptoms for a particular health issue are presented on the same time and severity scale. These scores are time-aligned with a presentation of the various measured parameters and a presentation of the responses to the various Boolean activities. The graphic time-alignment of all of this information provides a new paradigm in patient treatment analysis.

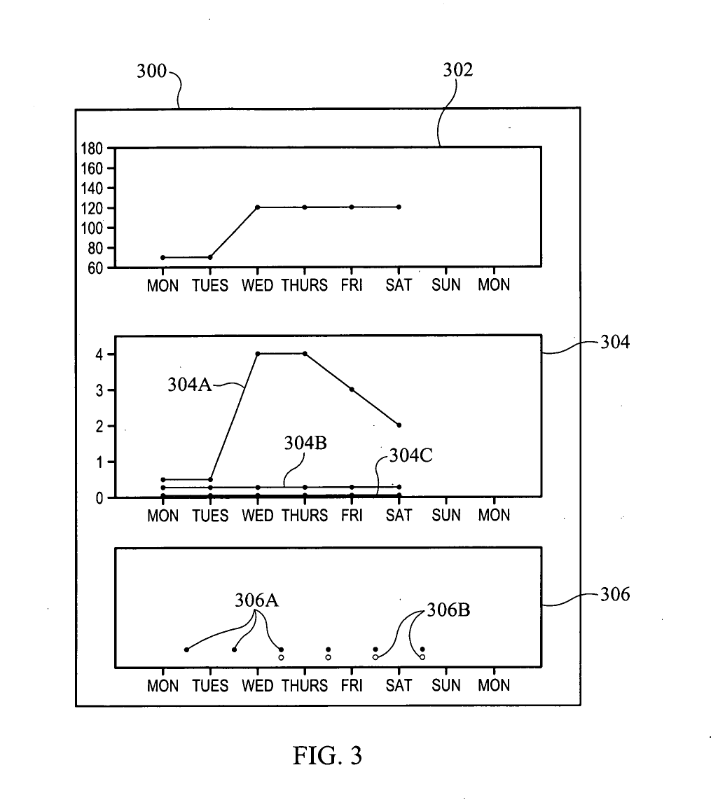

By way of an illustrative example, a graphical presentation 300 of a patient/user's time-lapse graphical health record is illustrated in FIG. 3 for a patient/user having a history of stroke. The graphical presentation can be displayed on device 202D of patient analyzer 202 and/or printed as a “hard copy” by device 202D or other device (not shown) coupled thereto. The same or similar display could also be made available on device 200D of patient/user 200 without departing from the scope of the present invention. The graphical presentation can be generated by processor 24 and then made available at device 202D (and optionally, at device 200D) via internet 100. Generating the graphical health record at system 10 reduces processing requirements and loads on devices 200D/202D. The graphical health record is a novel electronic health history/record that will greatly improve patient care.

In FIG. 3, a vertical arrangement of three time-aligned graphs 302, 304 and 306 comprises the essence of graphical presentation 300. As used herein, the phrase “vertical arrangement” defines a top-to-bottom arrangement on an electronic display “page” or a hardcopy “page”. In general, graph 302 presents measured parameters requested from the patient/user by the feature description, graph 304 presents the scaled symptom scores requested from the patient/user by the feature description, and graph 306 presents the Boolean activity responses requested from the patient/user by the feature description. The x-axis of each graph represents an identical time scale to thereby time-align all inputs provided by patient/user 200. The “top-to-bottom” order of the time-aligned graphs can be different from that shown without departing from the scope of the present invention.

In the illustrated example, graph 302 presents just measured heart rate values. Graph 304 presents scaled score inputs for swallowing, walking, and vision with the scaled score basis corresponding to that shown in FIG. 2. More specifically, graph 304A illustrates swallowing scores, graph 304B illustrates walking scores, and graph 304C illustrates vision scores. Graphs 304A-304C can be presented in unique ways (e.g., colors, line forms, etc.) to facilitate their distinction. For the illustrated example, it will be assumed that a “0” score for vision and walking are indicative of no problems being experienced by the patient/user. Graph 306 presents Boolean activity responses indicating that a first medication was taken via solid “dots” 306A and that a second medication was taken via open “dots” 306B. The time-aligned scale extends over the course of six days with measured parameters and scaled score inputs occurring at noon, and with medication administration occurring at 6 PM each day.

It will be assumed that the patient/user had a history of stroke with swallowing problems and was at risk of recurrence. It will also be assumed that the patient analyzer (e.g., physician) was unaware of the etiology, and therefore directed the patient/user to input the heart rate variable and rate/score their swallowing among other related symptoms such as walking and vision. In this simple example, it is clear there are only changes in swallowing and heart rate. The scaled score graphical presentation in combination with the measured parameter and Boolean activities associated with the disease chosen by the patient analyzer show the following:

the onset of swallowing difficulties is present;

the scaling of swallowing severity indicates a marked increase in severity;

the decreasing scaled swallowing result over time indicates the rate of improvement and degree of improvement, i.e., possibly predictive of recovery and outcome;

the associated simultaneous swallowing problem plus increased heart rate indicate a relationship between the two;

the fact that heart rate changed in association with onset of swallowing problems can lead the patient analyzer to the diagnosis of embolic cause as opposed to hemorrhagic cause, an important conclusion given that treatments are different;

the fact that heart rate increased at the same time as an embolus to the brain possibly indicates that there may be embolii to other regions as well, e.g., pulmonary embolus;

the fact that heart rate stays elevated while other symptoms (e.g., walking and vision in the illustrated example) are normal and the swallowing is improving indicates that there is another process occurring such as pulmonary embolus;

the lack of change in the other variables allows the patient analyzer to rule out other causes and diagnoses; and

the new medication (indicated by open “dots” 306B) added after stroke onset indicates that swallowing after stroke improved following administration of the new medication thereby indicating efficacy of treatment/effect of the new medication on stroke symptoms.

Graphical presentation 300 provides a visual platform that facilitates evaluation of a patient/user's interrelationships between combinations of variables that are of interest for a patient analyzer. The relationships are presented comparatively at the same times, but each variable is also time-aligned with each combination of chosen variables at every other time point in the graph.

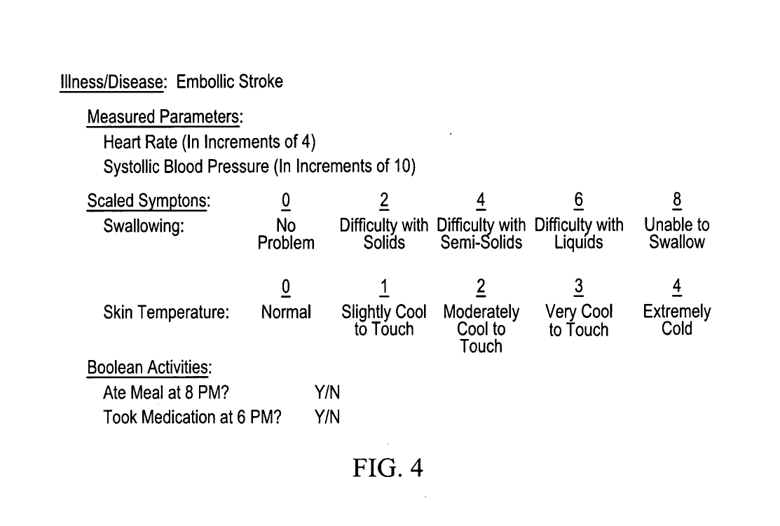

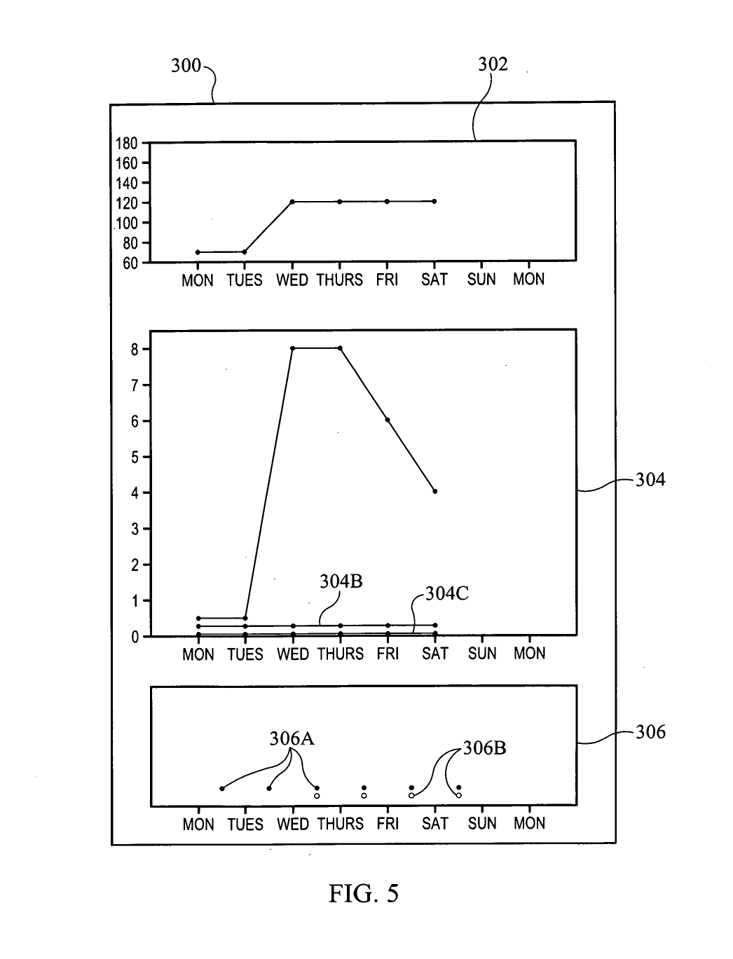

As mentioned above, database 222 stores modified feature descriptions for one or more of particular patients, a particular group of patients being studied, a particular strain of a virus/disease, etc. By way of an illustrative example, one type of modification could be the weighting of the scales used for particular symptoms depending on the relative importance of the symptoms. For example, FIG. 4 presents a modification to the scaling of the symptoms described above in FIG. 2. In this modification, the scale of swallowing is doubled as compared to the scale for skin temperature. As a result, the graphical presentation of user-supplied symptom scores shown in FIG. 5 graphically accentuates changes in swallowing as compared to changes in skin temperature thereby highlighting this symptom for a patient analyzer.

The present invention can also include the calculation and presentation of a composite score (hereinafter referred to as a “disease score”) in a time-aligned fashion at each presented time period. For example, each disease score “S_{D}” could be simple summation of the symptom scores at each time period “t” or

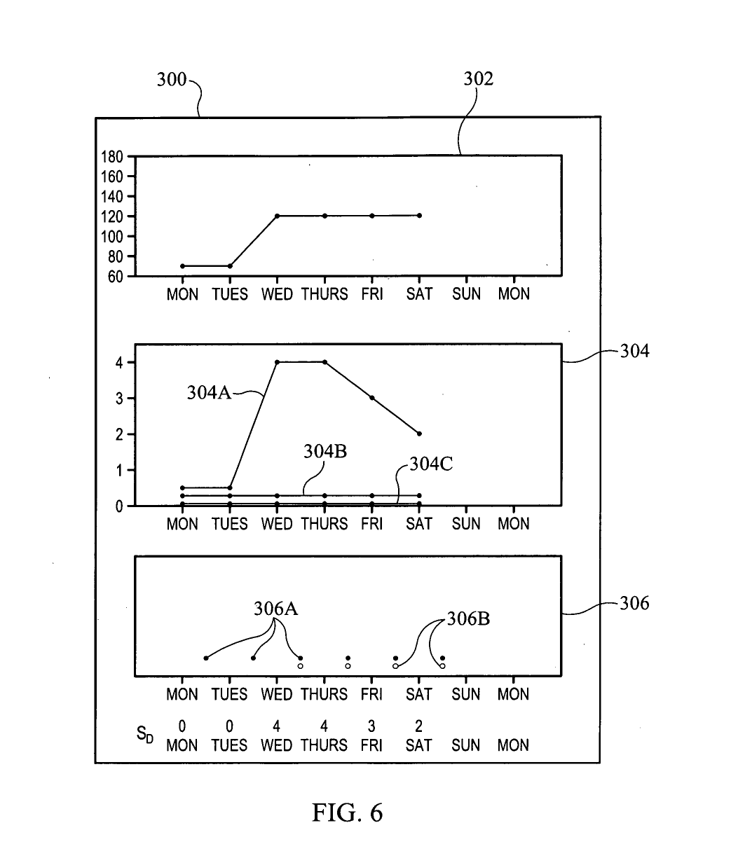

S_{D}(t)=S₁(t)+S₂(t)+S₃(t)+ . . .

where each Sₓ(t) is the scaled score provided by a patient at time “t”. FIG. 6 illustrates the above-described graphical presentation 300 to further include the time-aligned presentation of the disease scores S_{D} for the above described example shown in FIG. 3. In this simple example, a patient analyzer would recognize a significant change in the disease score on Wednesday thereby indicating that further analysis of the graphical presentation is warranted. While the above disease score example focuses on symptoms, it is to be understood that the disease score could also include contributions from the measured parameters and/or the Boolean activity responses without departing from the scope of the present invention.

Calculation of disease scores could also incorporate a weighting scheme predicated on the importance of a symptom, measured parameter, and/or Boolean activity. The importance/weighting would typically be defined by the patient analyzer. For example, assume that for the above-described example that the swallowing symptom (e.g., S₁) was deemed to be twice as important as the other two symptoms of walking (S₂) and vision (S₃). In this example, the disease score S_{D}(t) could be written as

S_{D}(t)=2S₁(t)+S₂(t)+S₃(t)

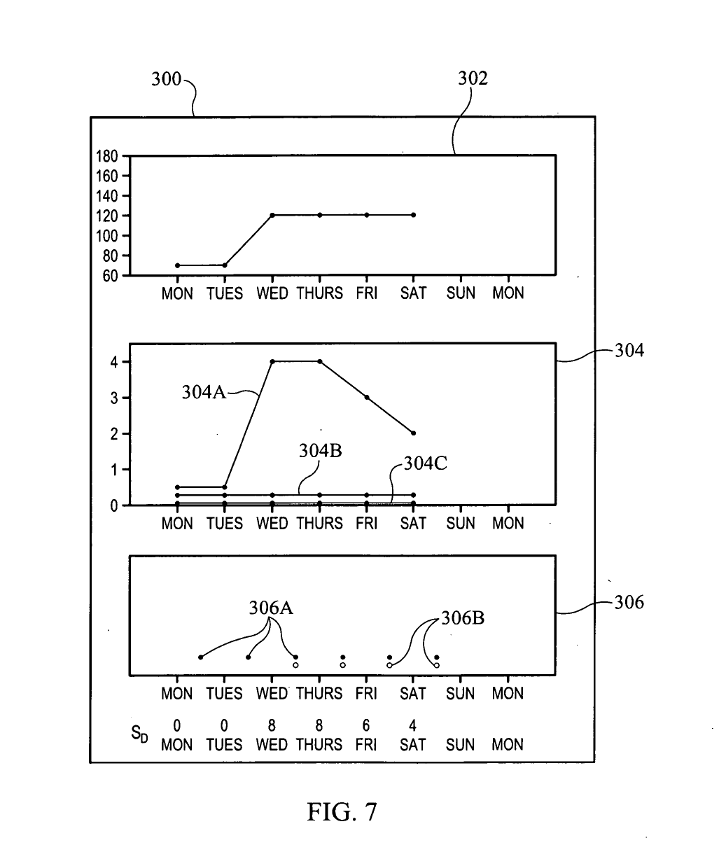

The resulting graphical presentation to include the weighted disease scores is illustrated in FIG. 7. Note that in this example the same symptom scaling is used by the patient and the graphical presentation. However, the greatly increased disease score on Wednesday provides an indication that the primary symptom of concern (i.e., swallowing) is most likely a concern.

The advantages of the present invention are numerous. The electronic health record generated by the present invention allows a patient's health issue to be monitored in real-time and/or over/after a period of time to provide a patient analyzer with accurate current and archived information. Since the patient is responding to queries on his health-issues in real or near real time, the patient and his healthcare provider no longer need to rely on patient memory when making treatment evaluations and decisions. The accuracy and immediacy of the health record allow the healthcare provider to be more responsive when a patient's treatment is not as effective as it could be. The important interrelationships for a given illness/disease can be readily evaluated as all information is presented in a visual graphic presentation to show rate-of-change. The scaled symptom scores can utilize the same scoring basis (e.g., 0 to 4) for different symptoms to clearly illustrate severity interrelationships. A symptom's scaling can also be weighted depending on a symptom's importance for a particular patient, disease, study focus, etc. Pre-set feature descriptions provide a baseline of important interrelated information for a given illness/disease that can then be customized for a particular patient/user's situations and/or particular patient analyzer's evaluation needs. The inclusion of the above-described disease score at each time period provides an additional evaluation tool for a patient analyzer that can signal the need for a more in-depth analysis of the graphical health record. By being internet-based, the system provides easy remote access by patient/users and patient analyzers.

Although the invention has been described relative to specific embodiments thereof, there are numerous variations and modifications that will be readily apparent to those skilled in the art in light of the above teachings. For example, the system could be intranet-based such that patient/users and patient analyzers access the system over a private network. The system could also be hardwired to devices used by patient/users and patient analyzers. It is therefore to be understood that the invention may be practiced other than as specifically described.

What is claimed as new and desired to be secured by Letters Patent of the United States is:

1. A method of generating a health record, comprising the steps of:
providing a processor and electronic data storage;
storing, in said data storage, a plurality of feature descriptions, each of said feature descriptions defining patient-answerable data queries associated with a health issue;
storing, in said data storage, sets of periodic responses to said data queries, each of said sets being associated with a time period;
processing, in said processor, said sets of said periodic responses to generate a graphical presentation of said sets of said periodic responses, said graphical presentation ordering said sets on a common time scale based on said time period; and
displaying said graphical presentation.

2. A method according to claim 1, wherein said processor and said data storage are accessed via the internet.

3. A method according to claim 1 wherein, for each of said feature descriptions, said data queries include data queries of symptoms associated with said health issue, data queries of measurable parameters of concern for said health issue, and data queries of Boolean-type activities of concern for said health issue.

4. A method according to claim 3, wherein said step of processing includes the step of grouping said periodic responses into a first group of said periodic responses associated with said symptoms, a second group of said periodic responses associated with said measurable parameters, and a third group of said periodic responses associated with said Boolean-type activities.

5. A method according to claim 4, wherein said first group of said periodic responses, said second group of said periodic responses, and said third group of said periodic responses are vertically aligned in said graphical presentation.

6. A method according to claim 1, further comprising the steps of:
generating a score for each of said sets of said periodic responses using at least a portion of said periodic responses associated with a corresponding one of said sets; and
displaying said score on said common time scale in correspondence with said graphical presentation of said corresponding one of said sets.

7. A method according to claim 1, wherein said step of processing includes the step of applying a weighting scheme to said sets of said periodic responses wherein said graphical presentation reflects said weighting scheme.

8. A method according to claim 6, wherein said step of generating includes the step of applying a weighting scheme to said portion of said periodic responses wherein each said score reflects said weighting scheme.

9. A method of generating a health record, comprising the steps of:
providing a processor and electronic data storage;
storing, in said data storage, a plurality of feature descriptions, each of said feature descriptions defining patient-answerable data queries associated with a health issue wherein, for each of said feature descriptions, said data queries include data queries of symptoms associated with said health issue, data queries of measurable parameters of concern for said health issue, and data queries of Boolean-type activities of concern for said health issue;
storing, in said data storage, sets of periodic responses to said data queries, each of said sets being associated with a time period;
processing, in said processor, said sets of said periodic responses to generate a graphical presentation of said sets of said periodic responses, said graphical presentation ordering said sets on a common time scale based on said time period;
generating a score for each of said sets of said periodic responses using at least a portion of said periodic responses associated with a corresponding one of said sets; and
displaying said graphical presentation and each said score simultaneously and in time alignment on said common time scale.

10. A method according to claim 9, wherein said processor and said data storage are accessed via the internet.

11. A method according to claim 9, wherein said step of processing includes the step of grouping said periodic responses into a first group of said periodic responses associated with said symptoms, a second group of said periodic responses associated with said measurable parameters, and a third group of said periodic responses associated with said Boolean-type activities.

12. A method according to claim 11, wherein said first group of said periodic responses, said second group of said periodic responses, and said third group of said periodic responses are vertically aligned in said graphical presentation.

13. A method according to claim 9, wherein said step of processing includes the step of applying a weighting scheme to said sets of said periodic responses wherein said graphical presentation reflects said weighting scheme.

14. A method according to claim 9, wherein said step of processing includes the step of applying a weighting scheme to said portion of said periodic responses wherein each said score reflects said weighting scheme.

15. A method of generating a health record, comprising the steps of:
providing a processor and electronic data storage adapted to be accessible via the internet;
storing, in said data storage, a plurality of feature descriptions, each of said feature descriptions defining patient-answerable data queries associated with a health issue;
transmitting one of said feature descriptions via the internet to a patient;
receiving, from the patient via the internet, sets of periodic responses to said data queries associated with said one of said feature descriptions, each of said sets being associated with a time period;
storing, in said data storage, said sets of said periodic responses to said data queries;
processing, in said processor, said sets of said periodic responses to generate a graphical presentation of said sets of said periodic responses, said graphical presentation ordering said sets on a common time scale based on said time period; and
transmitting said graphical presentation via the internet to a device adapted to display said graphical presentation.

16. A method according to claim 15 wherein, for each of said feature descriptions, said data queries include data queries of symptoms associated with said health issue, data queries of measurable parameters of concern for said health issue, and data queries of Boolean-type activities of concern for said health issue.

17. A method according to claim 16, wherein said step of processing includes the step of grouping said periodic responses into a first group of said periodic responses associated with said symptoms, a second group of said periodic responses associated with said measurable parameters, and a third group of said periodic responses associated with said Boolean-type activities.

18. A method according to claim 17, wherein said first group of said periodic responses, said second group of said periodic responses, and said third group of said periodic responses are vertically aligned in said graphical presentation.

19. A method according to claim 15, further comprising the steps of:
generating a score for each of said sets of said periodic responses using at least a portion of said periodic responses associated with a corresponding one of said sets; and
transmitting, via the internet, said score with said graphical presentation of said corresponding one of said sets to the device for the simultaneous display thereof in time alignment on said common time scale.

20. A method according to claim 15, wherein said step of processing includes the step of applying a weighting scheme to said sets of said periodic responses wherein said graphical presentation reflects said weighting scheme.

21. A method according to claim 19, wherein said step of generating includes the step of applying a weighting scheme to said portion of said periodic responses wherein each said score reflects said weighting scheme.

22. A system for generating a health record, comprising the steps of:
electronic data storage for storing a plurality of feature descriptions, each of said feature descriptions defining patient-answerable data queries associated with a health issue;
a processor for controlling distribution of one of said feature descriptions to a patient and for receiving, from the patient, sets of periodic responses to said data queries associated with said one of said feature descriptions, each of said sets being associated with a time period;
said data storage storing said sets of said periodic responses to said data queries;
said processor processing said sets of said periodic responses to generate a graphical presentation of said sets of said periodic responses that orders said sets on a common time scale based on said time period; and
said processor controlling distribution of said graphical presentation to a device adapted to display said graphical presentation.

23. A system as in claim 22 wherein, for each of said feature descriptions, said data queries include data queries of symptoms associated with said health issue, data queries of measurable parameters of concern for said health issue, and data queries of Boolean-type activities of concern for said health issue.

24. A system as in claim 23, wherein said periodic responses are separated into a first group of said periodic responses associated with said symptoms, a second group of said periodic responses associated with said measurable parameters, and a third group of said periodic responses associated with said Boolean-type activities.

25. A system as in claim 24, wherein said first group of said periodic responses, said second group of said periodic responses, and said third group of said periodic responses are vertically aligned in said graphical presentation.

26. A system as in claim 22, wherein said processor generates a score for each of said sets of said periodic responses using at least a portion of said periodic responses associated with a corresponding one of said sets, and wherein said processor distributes said score with said graphical presentation of said corresponding one of said sets to the device for the simultaneous display thereof in time alignment on said common time scale.

27. A system as in claim 22, wherein said processor applies a weighting scheme to said sets of said periodic responses wherein said graphical presentation reflects said weighting scheme.

28. A system as in claim 22, wherein said processor applies a weighting scheme to said portion of said periodic responses wherein each said score reflects said weighting scheme.
